(19) United States
(12) Patent Application Publication
(10) Pub. No.: US 2018/0301920 A1
(43) Pub. Date: Oct. 18, 2018

(54) MEMS DEVICE

(71) Applicant: Cirrus Logic International Semiconductor Ltd., Edinburgh (GB)

(72) Inventors: James Thomas DEAS, Edinburgh (GB); Paul WILSON, Linlithgow (GB)

(73) Assignee: Cirrus Logic International Semiconductor Ltd., Edinburgh (GB)

(21) Appl. No.: 15/951,240

(22) Filed: Apr. 12, 2018

Related U.S. Application Data
(60) Provisional application No. 62/485,240, filed on Apr. 13, 2017.

(30) Foreign Application Priority Data
Apr. 26, 2017 (GB) 1706638.2

(51) Int. Cl. H02J 7/00; H04R 3/00

(52) U.S. Cl. CPC H02J 7/0068; H04R 3/007; H02J 7/007

(57) ABSTRACT

Devices are disclosed including a transducer device comprising a first circuit for operating a MEMS transducer and connected to a supply terminal for receiving a power supply voltage, and a power consumption levelling circuit for dissipating a correction power and arranged to adjust the correction power to at least partially offset a change in power consumption of the first circuit due to a change in the power supply voltage.

### TECHNICAL FIELD

Embodiments disclosed herein relate to MEMS devices, including devices that include MEMS transducers.

### BACKGROUND INFORMATION

Consumer electronics devices are continually getting smaller and, with advances in technology, are gaining ever-increasing performance and functionality. This is clearly evident in the technology used in consumer electronic products and especially, but not exclusively, portable products such as mobile phones, audio players, video players, personal digital assistants (PDAs), various wearable devices, mobile computing platforms such as laptop computers or tablets and/or games devices. Requirements of the mobile phone industry, for example, are driving the components to become smaller with higher functionality and reduced cost. It is therefore desirable to integrate functions of electronic circuits together and combine them with transducer devices such as microphones and speakers. Micro-electro-mechanical system (MEMS) transducers, such as MEMS microphones, are therefore finding application in many of these devices.

Microphone or pressure sensor devices formed using MEMS fabrication processes typically comprise one or more membranes with electrodes for read-out/drive that are deposited on or within the membranes and/or a substrate or back plate. In the case of MEMS pressure sensors and microphones, the electrical output signal read-out is usually accomplished by measuring a signal related to the capacitance between the electrodes.

To provide protection the MEMS transducer will be contained within a package. The package effectively encloses the MEMS transducer and can provide environmental protection and may also provide shielding for electromagnetic interference (EMI) or the like. The package also provides at least one external connection for outputting the electrical signal to downstream circuitry. For microphones, pressure sensors and the like the package will typically have a sound port to allow transmission of sound waves to/from the transducer within the package, and the transducer may be configured so that the flexible membrane is located between first and second volumes, i.e. spaces/cavities that may be filled with air, and which are sized sufficiently so that the transducer provides the desired acoustic response. The sound port acoustically couples to a first volume on one side of the transducer membrane, which may sometimes be referred to as a front volume. The second volume, sometimes referred to as a back volume, on the other side of the one of more membranes is generally required to allow the membrane to move freely in response to incident sound or pressure waves, and this back volume may be substantially sealed. However, it will be appreciated by one skilled in the art that for MEMS microphones and the like the first and second volumes may be connected by one or more flow paths, such as small holes in the membrane, that are configured so as present a relatively high acoustic impedance at the desired acoustic frequencies but which allow for low-frequency pressure equalisation between the two volumes to account for pressure differentials due to temperature changes or the like.

The package may contain circuitry on the same or a separate semiconductor die as the membrane. The function of the circuitry is to measure a transducer signal related to the capacitance between the electrodes, and the circuitry may also provide one or more audio processing functions such as filtering, equalisation and the like. The circuitry may also provide bias to the electrodes, analog to digital conversion, analog or digital signal conditioning, an analog or digital output interface, and/or other functions.

The electrical transducer signal from the electrodes at normal sound levels is small, typically only a few millivolts. However, the supply voltage may have noise or ripple superimposed on it. For various reasons, a microphone may often be mounted at positions on the host device some way away from where the power supply voltage is generated, for example on the end of a long flex circuit to a corner of a device, or may be mounted for example under the antenna of a mobile phone where the supply voltage may be modulated by pulses of RF energy in the transmitted signal. In mobile phones, to save energy, it is common for major current-consuming blocks to be duty-cycled in operation to reduce average power consumption, for example in GSM phones with a duty-cycled RF transmitter, giving rise to time-varying changes in supply or ground connections despite reasonable attempts to mitigate these issues.

It is thus desirable to improve power supply rejection (PSR) performance of MEMS microphones such that variations and noise in a power supply voltage have little effect on any output signal from the circuitry. However, providing good power supply rejection has proven to be difficult to achieve in practice.

### SUMMARY OF EMBODIMENTS

According to a first aspect, there is provided a transducer device comprising circuitry including: a first circuit for operating a M EMS transducer and connected to a supply terminal for receiving a power supply voltage; and a power consumption levelling circuit for dissipating a correction power and arranged to adjust the correction power to at least partially offset a change in power consumption of the first circuit due to a deviation in the power supply voltage from an average power supply voltage so as to reduce variation in an overall power consumption of the circuitry.

In some embodiments, the correction power is adjusted based on the deviation in the supply voltage.

In some embodiments, the power consumption levelling circuit comprises a controlled current source providing a first current, and the first current is adjusted based on the deviation in the power supply voltage. The first current may in some embodiments be dependent on the value of a resistor in the power consumption levelling circuit, and wherein said resistor is of the same type as a resistor used to generate a bias current in the first circuit.

In some embodiments, the first circuit includes a first voltage regulator for providing a first regulated voltage from the power supply voltage, and wherein the power consumption levelling circuit includes a power dissipating portion located in proximity to the first voltage regulator.

The first circuit may in some examples include a first voltage regulator for providing a first regulated voltage from the power supply voltage and a second voltage regulating apparatus for providing a second regulated voltage from the power supply voltage, and wherein the power consumption levelling circuit includes a power dissipating portion comprising a first part located in proximity to the first voltage regulator and a second part located in proximity to the second voltage regulator.

In some embodiments, the power consumption levelling circuit comprises an operational amplifier arranged to receive an indication of a voltage of the terminal at a first input and an indication of a low pass filtered voltage of the terminal at a second input, and wherein an output of the operational amplifier is configured to control a current to adjust the correction power. The power consumption levelling circuit may in some cases comprise a first potential divider comprising a first resistor connected between the supply terminal and a first node and a second resistor connected between the first node and a second terminal, and a second potential divider comprising a third resistor connected between the terminal and a second node and a fourth resistor connected between the first node and the second terminal, the first node is connected to a first input of the operational amplifier, the second node is connected to an input of a low pass filter, an output of the low pass filter is connected to a second input of the operational amplifier, and the second terminal is for receiving a reference voltage. The reference voltage may be ground for example.

In some embodiments, the output of the operational amplifier is connected to a gate of a transistor, wherein the transistor is arranged to pass a gate-controlled current to dissipate the correction power.

In some embodiments, the power consumption levelling circuit comprises an analog to digital converter for providing a digital representation of the supply voltage, a digital processing circuit for receiving the digital representation of the supply voltage and for providing a digital control signal, and power dissipation apparatus for dissipating the correction power based on the digital control signal.

The device in some embodiments further comprises current measurement apparatus for measuring a current drawn by the first circuit, and wherein the power consumption levelling circuit is arranged to adjust the correction power in response to a change in the measured current to at least partially offset a change in power consumption of the first circuit due to a change in the current drawn by the first circuit.

In some embodiments, the device comprises a capacitive transducer connected to the first circuit, wherein the first circuit is arranged to perform signal processing functions on a signal determined from the capacitive transducer.

The device may define a common volume, the capacitive transducer may be in acoustic communication with the common volume and the circuitry may be in thermal communication with the common volume.

According to a second aspect, there is provided a semiconductor die integrating the device of the first aspect. The semiconductor die may further integrate a MEMS transducer for example.

According to a third aspect, there is provided an electronic apparatus comprising a transducer device according to the first aspect, wherein said apparatus is at least one of: a portable device; a battery power device; a computing device; a communications device; a gaming device; a mobile telephone; a personal media player; a laptop, tablet or notebook computing device.

According to a fourth aspect, there is provided a method comprising monitoring power consumption of a circuit; and in response to detecting a change in power consumption of the circuit, adjusting power dissipated by a power consumption levelling circuit to at least partially counter the change in power consumption of the circuit so as to reduce variation in an overall power consumption of the circuit and the power consumption levelling circuit.

According to a fifth aspect, there is provided a MEMS device comprising a capacitive transducer; a processing circuit configured to determine signals from the capacitive transducer; a terminal for receiving a power supply voltage; and a power correction circuit configured to provide a current, to increase the current in response to a decrease in the power supply voltage, and to decrease the current in response to an increase in the power supply voltage.

According to a sixth aspect, there is provided a circuit comprising a first portion for receiving a power supply voltage; and a power correction portion configured to consume a correction power, to increase the correction power in response to a decrease in the power supply voltage and to decrease the correction power in response to an increase in the power supply voltage.

According to a seventh aspect, there is provided a semiconductor die for operating a MEMS transducer, the semiconductor die comprising integrated circuitry, the integrated circuitry comprising a signal processing portion and a variable current source, the integrated circuitry arranged to vary the current from the variable current source depending on a voltage applied to a power supply terminal of the integrated circuitry so as to dissipate a power to at least partially cancel out a variation in power consumption of the signal processing portion due to a change in the voltage at the power supply terminal.

According to an eighth aspect, there is provided a MEMS microphone comprising a MEMS transducer; signal processing circuitry coupled to the MEMS transducer and a power supply; and power compensation circuitry coupled to the power supply and arranged to vary current drawn from the power supply in response to a change in voltage of the power supply voltage so as to maintain a substantially constant total power dissipation of the signal processing circuitry and power compensation circuitry.

### BRIEF DESCRIPTION OF THE FIGURES

Embodiments will now be described by way of non-limiting example only with reference to the accompanying Figures, in which:

FIG. 1 illustrates a cross section of an example of an integrated MEMS device;

FIG. 2 illustrates an example of at least a portion of integrated circuitry;

FIG. 3 illustrates an example of a chart illustrating performance of the device of FIG. 1 during testing;

FIG. 4 illustrates an example of an embodiment of circuitry coupled to a MEMS transducer;

FIG. 5 illustrates an example of an embodiment of power consumption levelling circuitry;

FIG. 6 illustrates a further example of an embodiment of power consumption levelling circuitry;

FIG. 7 illustrates another example of an embodiment of power consumption levelling circuitry;

FIG. 8 illustrates a further example of an embodiment of circuitry;

FIG. 9 illustrates an example implementation of circuitry; and

FIG. 10 illustrates another example of an implementation of circuitry.

### DETAILED DESCRIPTION OF EMBODIMENTS

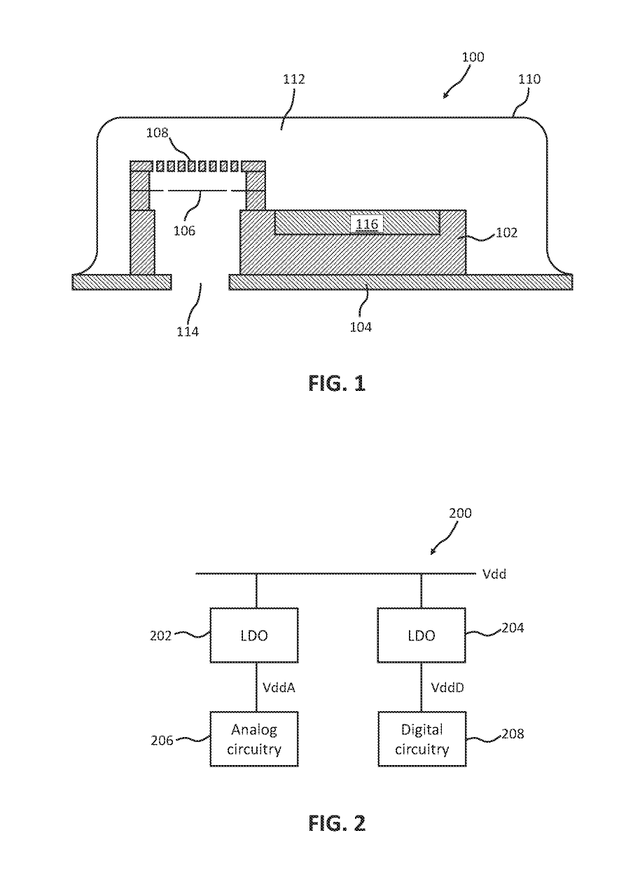

FIG. 1 illustrates a cross-section of an example of a packaged MEMS microphone device 100. The device 100 includes a semiconductor die 102 mounted on a package substrate 104. The semiconductor die 102 includes both circuitry 116 and a co-integrated MEMS transducer including a membrane 106 and back plate 108. The membrane 106 and back plate 108 are positioned adjacent to and spaced apart from each other, and each includes an electrode (not shown), or is conductive and thus forms an electrode, such that they form the plates of a capacitor. Therefore, in this example, the semiconductor die 102 contains integrated circuitry 116 and a MEMS transducer structure. In other examples the MEMS transducer elements may be implemented on a separate semiconductor die.

The integrated circuitry 116 and MEMS transducer may be packaged in a number of ways. For example, as shown in FIG. 1, the semiconductor die 102 comprising the MEMS transducer is mounted on the package substrate 104 and covered by a lid 110 to define a volume 112 which may serve as for example the back volume of a MEMS microphone. In examples where the MEMS transducer is implemented as a separate semiconductor die the semiconductor die 102 and the MEMS transducer semiconductor die may be attached separately to a common package substrate and covered by a common lid to define a common volume. However, other packaging types may instead be used. For instance, in wafer-level chip-scale packaging (WLCSP) examples the package substrate 104 may be absent, and external connections may be made directly from the lower surface of a single semiconductor die incorporating the transducer and circuitry, with a lid structure mounted directly onto the die to provide a back volume.

In general for space reasons and structural simplicity there will be a common volume communicating with both the MEMS transducer and associated integrated circuitry whether or not these are integrated on a single die or a plurality of die, and whether or not the device comprises a separate package substrate.

The package substrate 104 includes an acoustic port 114 that may comprise a sound port of a MEMS microphone. The back plate 108 includes a plurality of holes that provide channels from the volume between the membrane 106 and the back plate 108 to the volume 112. The membrane 106 includes one or more holes to allow low frequency pressure equalisation between the volume 112 and the air surrounding the device 100.

In use, sound or pressure waves may enter the acoustic port 114 of the MEMS microphone device 100 and interact with the membrane 106, causing the membrane to move in a vertical direction as shown in FIG. 1, or to tend to move in this direction. In other words, the membrane may experience a force in a direction towards or away from the back plate 108, due to a sound or pressure wave. An incident sound pressure wave, for example, may thus cause the distance between the membrane 106 and back plate 108, and their associated electrodes, to change, and therefore the capacitance between the electrodes changes. This change in capacitance can be detected by the integrated circuitry 116, which may output an electrical output signal representing the sound or pressure waves that caused the movement of the membrane 100. Accordingly, the device 100 may include connections (not shown), such as metal interconnects, between the electrodes and the integrated circuitry 116.

FIG. 2 illustrates an example of at least some of the circuitry 200 that may be included in the semiconductor die 102. The circuitry 200 may include one or more voltage regulators such as low-dropout (LDO) regulators. Two LDO regulators 202 and 204 are shown in FIG. 2. Each LDO regulator receives a voltage, such as a power supply voltage Vdd, and outputs a substantially constant voltage to other parts of the circuitry. For example, the LDO regulator 202 receives voltage Vdd and provides a first regulated voltage (VddA) to analog circuitry 206. Similarly, the LDO regulator 204 receives the voltage Vdd and provides a second regulated voltage (VddD) to digital circuitry 208. In one example implementation, the voltage Vdd is 1.8V, the first regulated voltage is 1.6V, and the second regulated voltage is 1.0V, though other voltages may be used in other implementations.

The LDO regulators 202 and 204 provide respective substantially constant voltages, i.e. substantially constant supply voltages, to the associated analog and digital circuitry 206 or 208 even in the presence of power supply fluctuations and noise. Therefore, in some implementations, the current consumption of the integrated circuitry is substantially constant even with changes ΔVdd in power supply voltage Vdd. As a result, the power consumption of the integrated circuit circuitry, being the product of the supply voltage Vdd and the current flowing from the supply terminal to ground, is proportional to the supply voltage level Vdd and thus changes linearly with ΔVdd.

In other examples the supply voltage for at least some of the analog or digital circuitry may be derived without using LDOs but bias voltages for components in the circuitry may be generated so as to still result in substantially constant current draw by the circuitry 200. For example, a bias current may be generated using a substantially supply independent reference voltage such as a bandgap voltage. In still other examples, the current drawn by the circuitry may vary due to variations and noise in the supply voltage Vdd, and hence the power consumption of the circuitry 200 may vary non-proportionally to the supply voltage.

The circuitry 200 shown in FIG. 2 is merely an example and other implementations of the integrated circuitry may include more or fewer components, or different components, to those shown in FIG. 2. For example, the integrated circuitry may have more or fewer LDO regulators, or may have no LDO regulators, and may include analog circuitry and/or digital circuitry as appropriate. In at least some implementations, however, the power consumption depends on the supply voltage level, and may thus fluctuate with fluctuations and noise in the supply voltage level.

A problem with the device 100 of FIG. 1 is that in use, the integrated circuitry 116 consumes power and generates heat, at least some of which dissipates into the air in the back volume 112. The integrated circuitry 116 is in thermal communication with the back volume. Thus as the power consumption changes due to fluctuations and noise in the power supply voltage level, the temperature of the air in the back volume 112 may thus increase and decrease. As a result, thermal expansion of the air in the back volume 112 may cause variation of the pressure in the back volume. Since the back volume is in acoustic communication with the membrane 116, this pressure is exerted on the membrane 106, resulting in movement of the membrane 106. This may be detected by the integrated circuitry 116 as a signal which may be indistinguishable from signals due to sound or pressure waves incident on the membrane via the acoustic port 114, particularly if the supply voltage modulation contains audio frequency components.

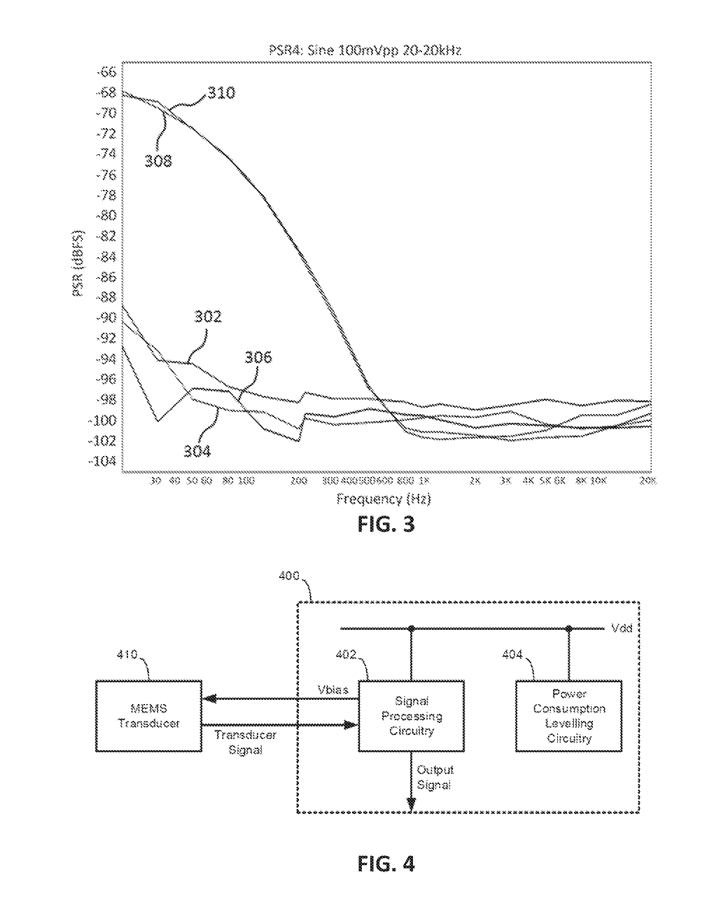

FIG. 3 illustrates the power supply rejection (PSR) performance of an example MEMS microphone device similar to the device 100 of FIG. 1 during testing with no acoustic stimulus present but with a sine wave of variable frequency superimposed on the supply voltage. FIG. 3 shows the amplitude of the resultant signal coupled onto the electrical output against frequency of the superimposed sine wave. The lower three curves 302, 304 and 306 represent the device in a vacuum, whereas the upper two curves 308 and 310 represent the device in air. It can be seen that the coupled output signal amplitude is relatively low and substantially independent of frequency in a vacuum, whereas in air the coupled output signal amplitude begins to rise below around 1 kHz and rises considerably as the frequency is lowered, reaching around −68 dBFS at 20 Hz, compared to the residual level of less than −90 dBFS coupled in a vacuum.

The cause for this is the repeated heating and cooling of the air in the back volume 112 (in particular the air closest to the surface of circuitry 116) due to the increase and decrease in the power consumption of the integrated circuitry 116, resulting in thermal modulation of the air pressure in the whole back volume and thus movement of the membrane 106 at the associated frequency. In other words, there is thermoacoustic coupling between the integrated circuitry 116 and the membrane 106, as the movement of the membrane may be detected by the integrated circuitry 116 indistinguishably from any movement of the membrane due to similar acoustic or sound pressure waves received via the acoustic port 114.

Embodiments of the invention recognise that the variation in power consumption of the integrated circuitry 116 shown in FIG. 1 causes variations in heat generated by the circuitry and hence causes thermo-acoustic coupling between the circuitry and the membrane 106, and hence affects the PSR performance of the device 100. Embodiments provide additional circuitry that dissipates additional power that varies based on the power supply voltage, to level (i.e. to reduce variations in) the overall power consumption of the device. For example, if the power supply voltage rises, the additional power dissipated by the additional circuitry falls to counteract the change in power consumption of other parts of the circuitry, and if the power supply voltage falls, the additional power dissipated by the additional circuitry rises. As a result of the reduction in variation in overall power consumption of a device, therefore, the variation in heat generated is also reduced. This reduces the effect of thermo-acoustic coupling between circuitry and the membrane and hence improves the PSR performance.

FIG. 4 illustrates an example of a transducer device comprising circuitry 400 according to an embodiment, shown coupled to a MEMS transducer 410. The circuitry 400 includes signal processing circuitry 402 that may perform similar functions to the circuitry 116 shown in FIG. 1. In this example the signal processing circuitry 402 is shown to provide a bias signal Vbias to the transducer 410, to receive a transducer signal from the transducer, and to generate an output signal therefrom.

The circuitry 400 also includes power consumption levelling circuitry 404. The levelling circuitry 404 dissipates power dependent on a power supply voltage Vdd, provided to both the signal processing circuitry 402 and levelling circuitry 404, in order to at least partially offset the variation in power consumption of the signal processing circuitry 402. As a result, the variation in overall power consumption of the circuitry 400 is at least reduced.

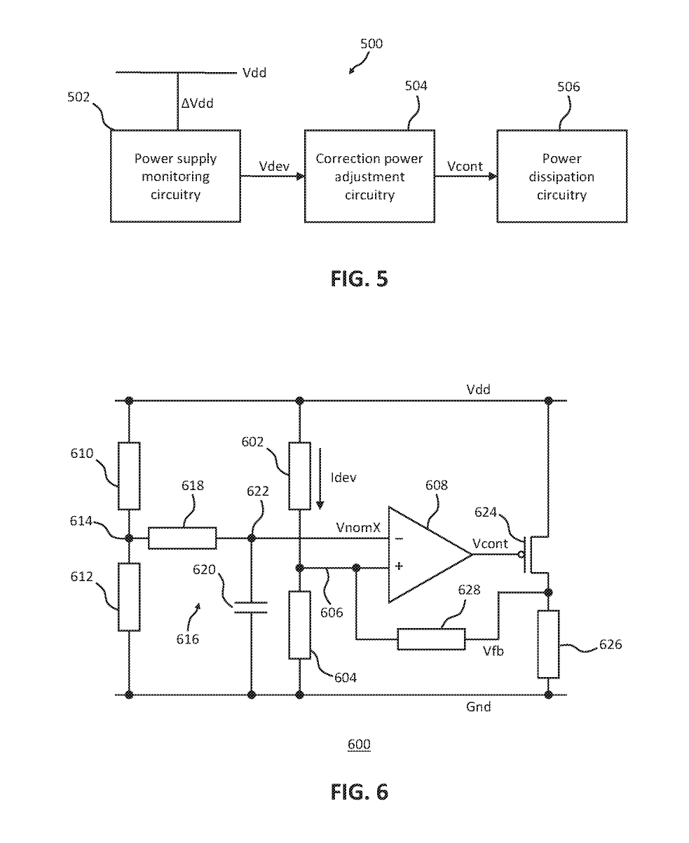

FIG. 5 shows an example of power consumption levelling circuitry 500. The circuitry 500 includes power supply monitoring circuitry 502 that monitors the power supply voltage Vdd. The power supply monitoring circuitry 502 provides an output that is an indication of a variation ΔVdd in the power supply voltage Vdd. For example, in the embodiment shown in FIG. 5, the output is a voltage Vdev that is a deviation in the power supply voltage Vdd from a voltage Vnom. The voltage Vnom may be a predetermined nominal voltage, an average voltage, an intended power supply voltage or any other suitable voltage. For example Vnom may be derived as an average voltage by applying a low pass filter to the supply voltage or to a divided-down version of the supply voltage. The deviation in the power supply voltage from an average voltage may also be derived directly by high-pass filtering the supply voltage or to a divided-down version of the supply voltage. The average voltage may change slowly over time, for example due to a battery voltage decreasing or a change in ambient temperature or due to drift in the value of some component due to ageing.

In other embodiments, the output of the monitoring circuitry 502 may be a signal other than a voltage signal, for example a current signal or digital word, that nevertheless is a representation of the variation ΔVdd in the power supply voltage Vdd.

The output of the monitoring circuitry 502 is provided to a correction power adjustment circuitry 504 that varies an amount of correction power dissipated by the circuitry 500 based on the output from the monitoring circuitry 502. For example, the adjustment circuitry 504 receives the signal from the monitoring circuitry 502, Vdev for example, and produces a control signal, for example a control voltage Vcont. The control signal is provided to power dissipation circuitry 506 that dissipates power based on the control signal. For example, the dissipation circuitry may include a controlled current source through which a compensation current Icomp flows controlled in response to a control voltage Vcont, hence dissipating power in components such as resistors or transistors in the path or paths through which this current flows from a supply voltage Vdd to ground Gnd. The adjustment circuitry 504 adjusts the control signal to vary the power dissipated by the circuitry 500 and hence at least partially offset a variation in power dissipation of other parts of the device, such as for example the signal processing circuitry 402 shown in FIG. 4.

The circuitry 500 can be implemented in a number of ways. For example, in some embodiments the circuitry 500 may be integrated on a single semiconductor die. In other embodiments, however, the circuitry 502 and 504 may be integrated on one or more separate semiconductor die or implemented as other types of physical circuitry.

FIG. 6 illustrates a further example of power consumption levelling circuitry 600. The circuitry 600 includes a first potential divider comprising resistors 610 and 612 connected in series between the power supply voltage Vdd and a second voltage. The second voltage may comprise, for example, a second power supply voltage, a ground voltage, or any other suitable fixed voltage. In the example shown in FIG. 6, the second voltage is a ground voltage Gnd.

A node, or terminal, 614 between the resistors 610 and 612 is connected to a low pass filter 616 comprising a resistor 618 and capacitor 620 connected in series between the node 614 and ground. A node 622 between the resistor 618 and capacitor 620 effectively provides an indication VnomX of a low pass filtered, scaled replica of the power supply voltage Vdd. For example, the voltage VnomX at node 622 may be a representation of an average (scaled) value of power supply voltage Vdd. The node 622 is connected to a first (inverting) input of an operational amplifier (op-amp) 608.

A second potential divider comprises resistors 602 and 604 connected between Vdd and the second voltage, in this example ground. In the absence of other connections, this second potential divider would provide at a node 606 between resistors 602 and 604 an indication of the instantaneous power supply voltage that in this example would be a representation of the (scaled) instantaneous power supply voltage Vdd. However the node 606 is connected to a second (non-inverting) input of the op-amp 608. Feedback around the op-amp 608, applied to this node 606 by the attached feedback resistor 628, forces this node 606 connected to the second (non-inverting) input of the op-amp 608 to sit at the same voltage as that at the first input of the op-amp. In this case this voltage is the filtered voltage VnomX indicative of the average value of the supply voltage Vdd.

Assuming the two potential dividers 610/612 and 602/604 have the same resistor ratio, then when Vdd is at its average value, the two nodes 606 and 622 will be at the same voltage without needing to be adjusted by any current flow out of node 606 via the feedback resistor 628. However any variation ΔVdd in the supply voltage will cause an incremental current Idev=ΔVdd/R1 to flow through resistor 602 and thence into resistor 628, where R1 is the resistance value of resistor 602. (Since node 606 is maintained at a constant voltage VnomX, a constant current will flow through resistor 604.)

Thus operational amplifier 608 is arranged to receive at a first input an indication Idev of an instantaneous supply voltage Vdd received at a supply voltage terminal and to receive at a second input an indication VnomX of a low pass filtered voltage of the supply voltage terminal

The output Vcont of op-amp 608 is provided to the gate of a p-type transistor 624, in this example a PMOS. The source of the transistor is connected to Vdd, and the drain is connected to ground Gnd via resistor 626. The drain of the PMOS transistor is also connected to the second, non-inverting, input of op-amp 608 via feedback resistor 628.

In operation, op-amp 608 responds to its inputs by modulating the voltage Vcont applied to the gate of PMOS 624 to control the current Icomp flowing from the source to the drain of the PMOS transistor. Assuming the feedback resistor 628 is of a substantially higher value Rfb than the value Rb of resistor 626, then a current Icomp of approximately the same value will also flow through resistor 626. Thus a current Icomp flows from Vdd to ground Gnd via transistor 624 and resistor 626, dissipating a total power Pcomp=Icomp.Vdd.

Quiescently, the voltage on both node 614 and 606 will be α.Vdd, where a is a potential divider ratio, assumed equal for the two potential dividers in this example. As mentioned above, the current through feedback resistor 628 will be zero, thus the voltage Vfb at node 630 will also be equal to α.Vdd. The current Icomp flowing through ballast resistor 626 will be thus equal to a value Icomp0=α.Vdd/Rb. The quiescent power dissipated due to this current Icomp0 flowing from Vdd to ground via transistor 624 and resistor 626, will thus be equal to a value Pcomp0=Icomp0.Vdd=α.Vdd²/Rb.

If the power supply voltage is now modulated to increase by an amount ΔVdd, an additional current Idev equal to ΔVdd/R1 will flow through resistor 602, and be forced through feedback resistor 628 by the op amp feedback. The resulting voltage drop across feedback resistor 628 implies a reduction by Rfb.Idev=Rfb.ΔVdd/R1 in the voltage Vfb on node 630 and thus a reduction ΔIcomp=Rfb.ΔVdd/(R1.Rb) in the current Icomp flowing through resistor 626.

Power dissipated due to the current Icomp flowing from supply Vdd to ground Gnd via transistor 624 and resistor 626, will thus be reduced by an amount ΔPc1 equal to ΔIcomp.Vdd=Rfb.ΔVdd.Vdd/(R1.Rb).

There will however be an increase in power dissipation due to the increased voltage across which the current through transistor 624 and resistor 626 flows of Icomp.ΔVdd=α.ΔVdd.Vdd/Rb (and also some terms in ΔVdd² which may be neglected). So the net reduction in dissipated compensation power is equal to a value ΔPcomp=(ΔVdd.Vdd/Rb).{(Rfb/R1)−α}.

Typically a may be 0.5 to set the common-mode input voltage and the quiescent value of Vfb conveniently to Vdd/2. The ratio Rfb/R1 may then be say 5 to allow a 10% variation in Vdd to cause a +/−Vdd/2 swing of Vfb, i.e. for Vfb to swing from rail to rail for the 10% Vdd variation or preferably a little smaller to allow some drain-source headroom for transistor 624. Thus the Rfb/R1 term will dominate over the a term to give a net reduction in dissipated compensation power Pcomp.

Similarly, if the supply voltage were modulated in a negative direction, the dissipated compensation power Pcomp would increase.

Alternatives of the example shown are envisaged. For example, a different transistor type and/or different connection arrangement of the op-amp inputs may also be used. For example, if PMOS 624 were replaced by an NMOS transistor, the NMOS would operate as a source follower and thus there would no longer be an inversion in polarity between Vcont and Vfb, so the op-amp inputs would need to be interchanged to preserve the negative polarity of the overall feedback. In some embodiments the power dissipation components such as PMOS 624 and resistor 626 or equivalents may effectively serve as the output stage of the op amp 608. Also, an embodiment where the two potential dividers have the same ratio is not a design constraint. Different ratios may lead to to quiescent current through the feedback resistor and an alteration of the quiescent bias points, which may be advantageous in some examples to adjust the operating headroom on circuit nodes or which may be compensated for if desired by additional bias current sources or level-shifting circuitry or the like.

Thus in summary, and relating also to FIG. 5, the operation of the power consumption levelling circuitry 600 when in use can also be illustrated in principle as follows. In use, power supply voltages such as Vdd and ground Gnd are provided to appropriate nodes.

Power supply monitoring circuitry comprising the two resistor potential dividers 610, 612 and 602, 604 and also comprising a low pass filter (LPF) comprising components 618, 620 delivers a signal output that is an indication of a variation in the power supply voltage Vdd (in this case the signal being a current Idev rather than voltage Vdev) into a low-impedance input of correction power adjustment circuitry comprising op amp 608. The correction power adjustment circuitry delivers a control signal Vcont that is provided to correction power dissipation circuitry comprising PMOS 624 and resistor 626 that consequently varies an amount of correction power these elements dissipate. Rather than open-loop control by Vcont, in this embodiment the power dissipation circuitry provides a feedback signal Vfb back to the correction power adjustment circuitry to allow tighter control of the dissipated power.

When there is a change ΔVdd in the power supply voltage Vdd, neglecting the small power dissipated by the power supply monitoring and correction power adjustment circuitry, the power dissipated is reduced by an amount β.ΔVdd where β has the dimensions of current and is equal to Vdd/Rb.{(Rfb/R1)−α}.

Referring back to circuitry in embodiments similar to FIG. 4, a change ΔVdd in supply voltage Vdd may alter the power dissipated in the signal processing circuitry 402 and the power consumption levelling circuitry 404. For embodiments where the current consumption of signal processing circuitry 402 is independent of the supply voltage, and equal to a value Isp, the change in power dissipation of the signal processing circuitry 402 due to an increase ΔVdd in the voltage supply will be given by ΔPs=Isp.ΔVdd. The decrease in power dissipation of the power levelling module will be β.ΔVdd. Thus, by setting the values R1, Rfb, Rb of resistors 602, 628 and 626 in the power levelling module so that 13 is equal to Isp, any increase in power dissipated by the signal processing circuitry 402 will be cancelled by the decrease in power dissipated by the power levelling module, in particular in the power dissipation module, giving no change in overall power dissipated by for example the integrated circuitry of FIG. 4. Thus there will be no modulation of temperature of air in the back volume and no disturbance of the membrane to give power-supply related output signals.

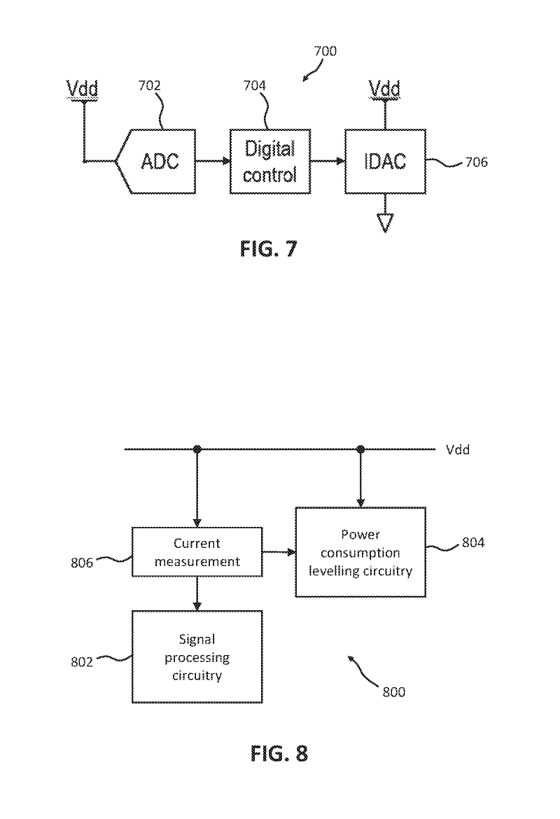

FIG. 7 illustrates a further example of power consumption levelling circuitry 700, which may be an example of the circuitry 404 shown in FIG. 4. The circuitry 700 implements power consumption compensation at least partially in the digital domain. The circuitry 700 includes for example an analog-to-digital converter (ADC) 702 serving, for example, as power supply monitoring circuitry that receives the power supply voltage Vdd and provides a digital representation of the power supply voltage to a controller 704 serving, for example, as correction power adjustment circuitry. This controller 704 may comprise fixed function and/or programmable digital processing circuitry. The controller monitors the digital representation of Vdd and provides an output to a current-output digital-to-analog converter (IDAC) 706 serving, for example, as power dissipation circuitry. The IDAC 706 produces a current that is representative of the digital output of the controller 704. The IDAC current will flow between supply Vdd and ground Gnd and will thus dissipate compensation power adjusted based on the monitored modulation ΔVdd of Vdd. In some embodiments, for example, the controller 704 may implement equations or a look-up table (LUT) to provide appropriate compensation current Icomp. In other embodiments, however, the controller 704 may implement other functions to provide a value to IDAC such that a compensation current is produced from which the resulting power at least partially counters a change in power consumption of other parts of a device due to Vdd variation. The equations or look-up table coefficients may also readily take account of more complicated variations of signal processing circuitry power dissipation versus supply, and may also allow simple correction for variation in a nominal Vdd used in the expression for β, or variation in nominal supply current of the signal processing circuitry due to the circuitry operating in predetermined distinct operating modes or configurations or operating with a different frequency of applied clocks.

FIG. 8 illustrates another embodiment of circuitry 800 that may comprise signal processing circuitry 802, which may be similar to signal processing circuitry 402 of FIG. 4. The circuitry 800 also includes power consumption levelling circuitry 804 and current measurement circuitry 806. The current measurement circuitry 806 measures the current consumed by signal processing circuitry 802 and provides a representation of the measured current to power consumption levelling circuitry 804. The levelling circuitry 804 may adjust the compensation power based on changes in the measured level of current drawn by the signal processing circuitry 802. Changes in the measured level of current drawn by the signal processing circuitry 802 may be due to changes in the power supply voltage. Changes in the measured level of current drawn by the signal processing circuitry 802 may be due to other causes, for example short-term changes in processing load or operating mode or frequency of an applied clock. Levelling circuitry 804 may adjust and dissipate compensation power to at least partially offset a change in power consumption of the signal processing circuitry 802 due to changes in the supply current drawn. The power consumption levelling circuitry at least partially levels the overall power consumption of the circuit 800 to reduce the impact on other components, such as on a membrane of a MEMS transducer for example.

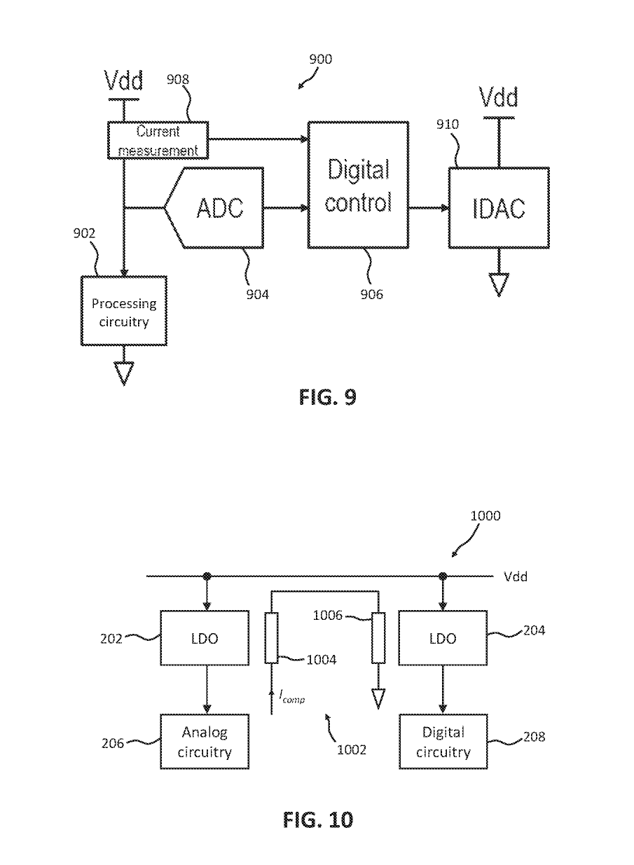

FIG. 9 illustrates a further embodiment of circuitry 900 that may be an implementation of the circuitry 800 of FIG. 8. The circuitry 900 includes processing circuitry 902 that may provide signal processing functions or other suitable functions and may be similar to circuitry 402, 802 shown in FIGS. 4 and 8 respectively. The circuitry 900 includes an ADC 904 providing a digital representation of the supply voltage Vdd to a digital controller 906, and current measurement circuitry 908 providing a representation of the current consumption of processing circuitry 902 to the controller 906. The controller 906 provides a digital value to IDAC 910, which controls a compensation current used to dissipate compensation power. The controller 906 can thus control the compensation power to account for changes in both the supply voltage Vdd and changes in the current drawn by processing circuitry 902, whether due to supply voltage changes or other factors.

In some of the above embodiments, compensation current used to dissipate compensation power is defined dependent on a component of the power consumption levelling circuitry that may for example be a resistance, such as a resistor or multiple resistors, for example resistor 626 of FIG. 6. In some embodiments, the resistor may be of the same type as at least one resistor used to define bias currents in the signal processing circuitry, or in a LDO as shown in FIG. 2 for example. As a result, process variations that affect resistances of resistors in the LDO or signal processing circuitry for example may also affect one or more resistances in the compensation current defining component and may result in the bias currents and the compensation currents scaling in the same way with process variation or temperature and preserving the cancellation of the respective power dissipation changes.

In some embodiments, circuitry such as signal processing circuitry may consume a varying amount of power as a result of variations in power supply voltage Vdd. Therefore, a component of the power dissipation circuitry, i.e. a power dissipation component, that dissipates a substantial portion of the compensation power can advantageously be physically located in proximity to the signal processing circuitry. This may reduce the variation of heat across the device, as the heat reduction when for example signal processing circuitry consumes less power can be offset by additional heat generated by the dissipation component that is located in proximity to, such as close to or adjacent to, the signal processing circuitry, in contrast to say being located at opposite ends of the circuitry. Where there are multiple parts of circuitry that each can vary their power consumption due to changes in the supply voltage, the power dissipation circuitry may be distributed such that a portion of the power dissipation circuitry comprising one or more power dissipation components is in proximity to each part of the circuitry.

FIG. 10 illustrates an example of circuitry 1000 that includes first and second LDOs 202 and 204, analog circuitry 206 and digital circuitry 208. Components similar to those shown in FIG. 2 are given like reference numerals. The circuitry 1000 includes power dissipation circuitry 1002 that passes power compensation current Icomp. The compensation current passes through two series resistors 1004 and 1006 of the power dissipation circuitry 1002, and then to ground Gnd.

In operation, analog circuitry 206 and digital circuitry 208 will receive respective supply voltages that are independent of the supply voltage Vdd, and will thus each dissipate a power independent of Vdd. Any change in overall power dissipation due to changes in Vdd will be due to the change in voltage drop across each LDO, and so any changes in heat generated will also be concentrated in the LDO circuit blocks, such as for example in pass transistors. Thus, power dissipation circuitry 1002 may be distributed such that an appropriate portion of the power dissipation circuitry is in proximity to each LDO, in particular each pass transistor. Thus the resistor 1004 may be located in proximity to the LDO 202, whereas the resistor 1006 may be located in proximity to LDO 204. Likewise, transistors passing the controlled power compensation current may also be placed physically close to components of the LDOs.

In the above examples, signal processing circuitry is referred to as an example. The term “signal processing circuitry” should be interpreted broadly, including not just processing such as analog or digital filtering but also other associated functions necessary to obtain and process signals from the transducer, such as analog to digital conversion, bias voltage generating and the like. The circuitry may be integrated on a semiconductor die, and the transducer device may include a MEMS transducer. The MEMS transducer may be included on the same semiconductor die that includes the other circuitry described above, or may be implemented on a separate semiconductor die. A packaged device may include the transducer, the signal processing circuitry and the power consumption levelling circuitry. The packaged device may therefore comprise a packaged MEMS microphone device in some examples.

Embodiments of the invention may be implemented on one or more semiconductor die, and within integrated circuit packages such as those including a substrate and lid, or other types of packages, for example wafer-level chip-scale packaging.

Furthermore, the circuits or devices may be included within any suitable type of electronic apparatus, such as a mobile computing device for example a laptop or tablet computer, a mobile telephone or smartphone, a desktop computer, a games console, a remote control device, a home automation controller or a domestic appliance including a domestic temperature or lighting control system, a toy, a machine such as a robot, an audio player, a video player, or the like.

Where functions are implemented using programmable digital processing circuitry, program instructions to be executed or parameter data to be used may be stored in non-transient form in memory in the apparatus, with the instructions or data being stored either during manufacture of the apparatus or by upload while the apparatus is in use.

In the above examples, a power supply voltage Vdd and ground Gnd are given as being connected to particular nodes. However, in some embodiments these may be interchanged or replaced by other voltages, such as first and second voltages. Additionally or alternatively, where a component is indicated to be connected between two nodes, this is intended to indicate that the component may be connected directly between these nodes, or alternatively in series with other circuit components. For example in FIG. 4, there may be LDOs connected between supply voltage Vdd and one or both of circuit blocks 402 or 404.

The skilled person will recognise that at least some aspects of the above-described apparatus and methods may be embodied as processor control code, for example on a non-transitory storage or carrier medium such as a disk, CD- or DVD-ROM, programmed memory such as read only memory (Firmware), or on a data carrier such as an optical or electrical signal carrier. For some applications, embodiments will be implemented on a DSP (Digital Signal Processor), ASIC (Application Specific Integrated Circuit) or FPGA (Field Programmable Gate Array). Thus the code may comprise conventional programme code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

It should be noted that the above-mentioned embodiments are illustrative rather than limiting embodiments, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

What is claimed is:

1. A transducer device comprising:
circuitry including:
a first circuit for operating a MEMS transducer and connected to a supply terminal for receiving a power supply voltage; and
a power consumption levelling circuit for dissipating a correction power and arranged to adjust the correction power to at least partially offset a change in power consumption of the first circuit due to a deviation in the power supply voltage from an average power supply voltage so as to reduce variation in an overall power consumption of the circuitry.

2. The device of claim 1, wherein the correction power is adjusted based on the deviation in the supply voltage.

3. The device of claim 1, wherein the power consumption levelling circuit comprises a controlled current source providing a first current, and wherein the first current is adjusted based on the deviation in the power supply voltage.

4. The device of claim 3, wherein the first current is dependent on the value of a resistor in the power consumption levelling circuit, and wherein said resistor is of the same type as a resistor used to generate a bias current in the first circuit.

5. The device of claim 1, wherein the first circuit includes a first voltage regulator for providing a first regulated voltage from the power supply voltage, and wherein the power consumption levelling circuit includes a power dissipating portion located in proximity to the first voltage regulator.

6. The device of claim 1, wherein the first circuit includes a first voltage regulator for providing a first regulated voltage from the power supply voltage and a second voltage regulating apparatus for providing a second regulated voltage from the power supply voltage, and wherein the power consumption levelling circuit includes a power dissipating portion comprising a first part located in proximity to the first voltage regulator and a second part located in proximity to the second voltage regulator.

7. The device of claim 1, wherein the power consumption levelling circuit comprises an operational amplifier arranged to receive an indication of a voltage of the terminal at a first input and an indication of a low pass filtered voltage of the terminal at a second input, and wherein an output of the operational amplifier is configured to control a current to adjust the correction power.

8. The device of claim 7, wherein the power consumption levelling circuit comprises a first potential divider comprising a first resistor connected between the supply terminal and a first node and a second resistor connected between the first node and a second terminal, and a second potential divider comprising a third resistor connected between the terminal and a second node and a fourth resistor connected between the first node and the second terminal, the first node is connected to a first input of the operational amplifier, the second node is connected to an input of a low pass filter, an output of the low pass filter is connected to a second input of the operational amplifier, and the second terminal is for receiving a reference voltage.

9. The device of claim 7, wherein the reference voltage is ground.

10. The device of claim 7, wherein the output of the operational amplifier is connected to a gate of a transistor, wherein the transistor is arranged to pass a gate-controlled current to dissipate the correction power.

11. The device of claim 1, wherein the power consumption levelling circuit comprises an analog to digital converter for providing a digital representation of the supply voltage, a digital processing circuit for receiving the digital representation of the supply voltage and for providing a digital control signal, and power dissipation apparatus for dissipating the correction power based on the digital control signal.

12. The device of claim 1, further comprising current measurement apparatus for measuring a current drawn by the first circuit, and wherein the power consumption levelling circuit is arranged to adjust the correction power in response to a change in the measured current to at least partially offset a change in power consumption of the first circuit due to a change in the current drawn by the first circuit.

13. The device of claim 1, comprising a capacitive transducer connected to the first circuit, wherein the first circuit is arranged to perform signal processing functions on a signal determined from the capacitive transducer.

14. The device of claim 13, wherein the device defines a common volume, and wherein the capacitive transducer is in acoustic communication with the common volume and the circuitry is in thermal communication with the common volume.

15. A semiconductor die integrating the device of claim 1.

16. The semiconductor die of claim 15, further integrating a MEMS transducer.

17. An electronic apparatus comprising a transducer device as claimed in claim 1, wherein said apparatus is at least one of: a portable device; a battery power device; a computing device; a communications device; a gaming device; a mobile telephone; a personal media player; a laptop, tablet or notebook computing device.

18. A method comprising:
monitoring power consumption of a circuit; and
in response to detecting a change in power consumption of the circuit, adjusting power dissipated by a power consumption levelling circuit to at least partially counter the change in power consumption of the circuit so as to reduce variation in an overall power consumption of the circuit and the power consumption levelling circuit.

19. A semiconductor die for operating a MEMS transducer, the semiconductor die comprising integrated circuitry, the integrated circuitry comprising a signal processing portion and a variable current source, the integrated circuitry arranged to vary the current from the variable current source depending on a voltage applied to a power supply terminal of the integrated circuitry so as to dissipate a power to at least partially cancel out a variation in power consumption of the signal processing portion due to a change in the voltage at the power supply terminal.
